(19) United States
(12) Patent Application Publication
(10) Pub. No.: US 2016/0260321 A1
(43) Pub. Date: Sep. 8, 2016

(54) APPARATUS AND METHOD FOR DATA COMMUNICATION THROUGH AUDIO CHANNEL

(71) Applicant: MINGCHIH HSIEH, SARATOGA, CA (US)

(72) Inventor: MINGCHIH HSIEH, SARATOGA, CA (US)

(21) Appl. No.: 15/153,645

(22) Filed: May 12, 2016

Related U.S. Application Data
(63) Continuation-in-part of application No. 14/191,173, filed on Feb. 26, 2014.

(51) Int. Cl. G08C 23/02; G10L 19/018

(52) U.S. Cl. CPC G08C 23/02; G10L 19/018

(57) ABSTRACT

A method is provided, which comprises: receiving a radio frequency signal; generating a first radio signal by demodulating and decoding the received radio frequency signal; detecting if a data embedding mode is used; extracting a first data signal from the first radio signal in response to the data embedding mode as being detected; and outputting the processed first radio signal after extraction.

### PRIORITY CLAIM AND CROSS-REFERENCE

This application claims priority to U.S. patent application Ser. No. 14/191,173 filed Feb. 26, 2014 the disclosure of which is hereby incorporated by reference.

### FIELD OF THE INVENTION

This invention relates to an apparatus and method for data communication through audio channels.

### BACKGROUND

Modern multimedia players or recorders are usually able to support audio streaming functions. Moreover, it is often desirable for users to control the multimedia content being played or to be played in a wireless fashion. For example, instructional data is usually required for controlling the playback of audio signal. Similarly, information provided by the media player on the multimedia being played, including the title, performer's name, or the length of the multimedia, may be of interest to the users and be accessible to the users.

A common approach for transporting data while playing multimedia involves adopting additional digital channels. Alternatively, concurrent transmission of both the data and audio signals may be accomplished following a protocol. Such protocol may be one of the adopted industrial standards, such as WiFi and Bluetooth. Bluetooth supports a stereo-type audio transmission through an advanced audio distribution profile (A2DP). Also, an audio/video remote control profile (AVRCP) compatible with A2DP is proposed for transmitting control data. Furthermore, a serial port profile (SPP) for Bluetooth is provided for transmitting information data. The above-mentioned protocols may support audio and data signal transmission through wireless channels.

### SUMMARY

It is found that the additional channel for communicating data or control signals is a heavy burden for wireless communication. Wireless channels are highly valued and may not be easily available since most wireless bands should be used with permission. Further, the implementation of standardized protocols, such as Bluetooth, involves complex code-construction efforts. In some cases, multimedia device vendors or service providers may encounter other difficulties in using some ports for transmitting data, such as licensing or compatibility issues. The transmission of information/control data may not be accordingly successful if the above issues are not adequately addressed. As a result, a convenient approach implementing a user-friendly multimedia transmission with concurrent data communication is needed.

In the present disclosure, a data transmission and reception mechanism to mitigate the above deficiencies is proposed. It is an objective of this disclosure to propose embedding the data within the audio channel without involvement of existing protocols or additional wireless channels. The data may be allocated in a predetermined time period or frequency of an audio channel. In addition, the allocated time period or frequency is arranged to not be perceivable to human hearing. Therefore, the data can be simultaneously transmitted in a hearing-friendly, efficient, and cost-effective fashion when the audio signal is being played.

In an embodiment of the present invention, a method is provided, which comprises: receiving a radio frequency signal; generating a first radio signal by demodulating and decoding the received radio frequency signal; detecting if a data embedding mode is used; extracting a first data signal from the first radio signal in response to the data embedding mode as being detected; and outputting the processed first radio signal after extraction.

In another embodiment of the present invention, a transmitter is provided. The transmitter comprises a first encoder configured to generate an audio signal and a second encoder configured to generate a data signal. The transmitter also includes a controller configured to determine a data embedding mode and parameters associated therewith for the audio signal and the data signal. The transmitter further comprises a signal combiner, configured to generate a data-embedding audio signal by embedding the data signal into the audio signal in response to the controller.

In yet another embodiment of the present invention, a receiver is provided. The receiver comprises a demodulation module configured to generate a first audio signal from a radio frequency signal, and a controller configured to detect a data embedding mode and parameters associated thereto for the first audio signal. The receiver further comprises a signal extractor, configured to extract a data signal from the first audio signal based on the data embedding mode and the parameters.

### BRIEF DESCRIPTION OF THE DRAWINGS

The accompanying drawings, which are incorporated in and constitute a part of this specification, illustrate embodiments of the disclosure and, together with the description, serve to explain the principles of the invention.

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

A more complete understanding of the present disclosure may be derived by referring to the detailed description and claims when considered in connection with the Figures, where like reference numbers refer to similar elements throughout the Figures.

FIG. 1 is a block diagram of a transmitter in accordance with some embodiments of the present disclosure.

FIG. 2A is a diagram of a time-domain embedding scheme for the transmitter of FIG. 1, in accordance with some embodiments of the present disclosure.

FIG. 2B is a diagram of a frequency-domain embedding scheme for the transmitter of FIG. 1, in accordance with some embodiments of the present disclosure.

FIG. 3 is a block diagram of a transmitter in accordance with some embodiments of the present disclosure.

FIG. 4 is a block diagram of a receiver in accordance with some embodiments of the present disclosure.

FIG. 5 is a flow diagram of a communication method in accordance with some embodiments of the present disclosure.

FIG. 6 is a flow diagram of a communication method in accordance with some embodiments of the present disclosure.

### DETAILED DESCRIPTION

In order to make the present disclosure completely comprehensible, detailed steps and structures are provided in the following description. Obviously, implementation of the present disclosure does not limit special details known by persons skilled in the art. In addition, known structures and steps are not described in details, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed embodiments, and is defined by the claims. The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment. References to “one embodiment,” “an embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

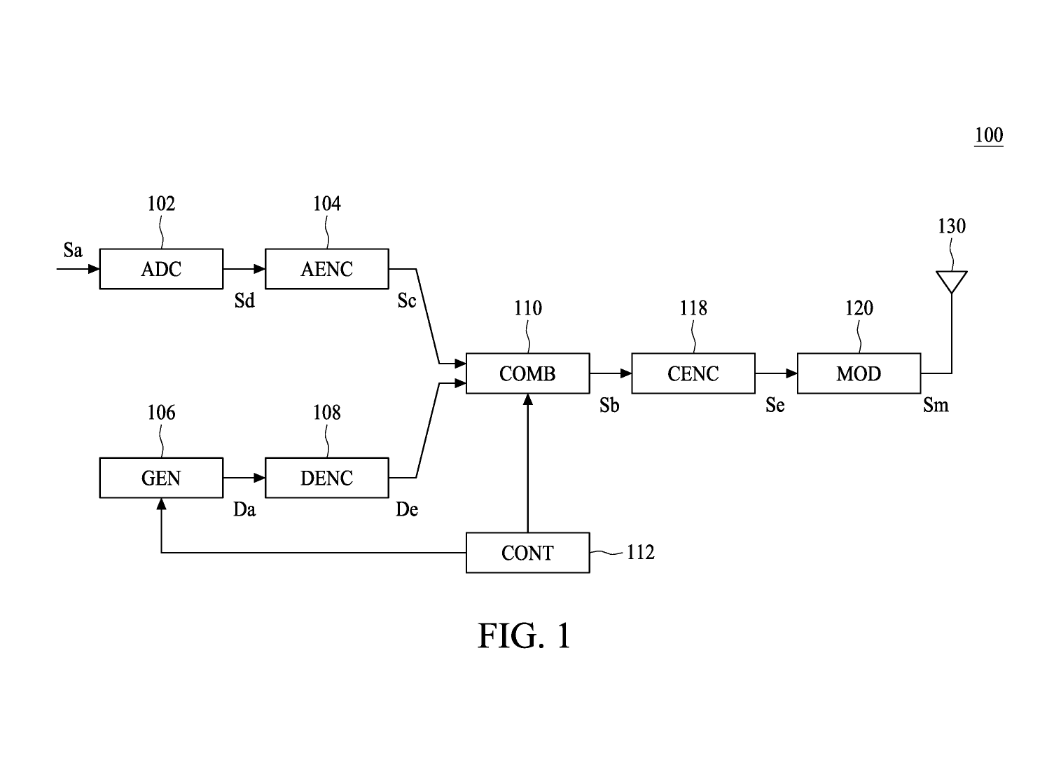

FIG. 1 is a block diagram of a transmitter 100 in accordance with some embodiments of the present disclosure. The transmitter 100 comprises an analog-to-digital converter (ADC) 102, a first audio signal encoder (AENC) 104, a data generator 106, a data encoder (DENC) 108, a signal combiner (COMB) 110, a second audio signal encoder (CENC) 118, a controller (CONT) 112, and a modulation module (MOD) 120.

The ADC 102 is configured to receive an audio signal Sa, and convert the audio signal Sa into a digital format Sd with a resolution of n bits, where n is a natural number. The conversion fidelity for the audio signal Sa is dependent upon the bit number n of the ADC 102. The ADC 102 may be implemented in various types, such as a flash-type, a sigma-delta type, a dual slope type and a successive approximation type. In some embodiments, the ADC 102 is constructed by at least a signal sampler, a signal comparator, a low-pass filter, a register, or a combination thereof.

The first audio signal encoder 104 is configured to encode the digitized audio signal Sd from the ADC 102. Specifically, the first audio signal encoder 104 is configured to generate an encoded audio signal Sc in response to the digital signal Sd. In some embodiments, the encoding procedure may comprise signal compression. In addition, the signal compression may involve lossy compression such that the encoded data Sc would consume less transmission bandwidth than its uncompressed counterpart Sd. The first audio signal encoder 104 may be constructed by a low-pass filter or band-pass filter.

In some embodiments, the input audio signal Sa is provided as audio samples, which have been encoded by another encoder protocol. Such audio samples may not be arranged in a same playback order as its analog audio waveform. In that case, the first audio signal encoder 104 is able to process the audio signal Sd in order to restore a sequence of digital samples Sc representing a digital-domain counterpart of its original audio waveform.

The data generator 106 is configured to generate information containing data or control data., collectively referred to as a data signal Da. In some embodiments, the data generator 106 comprises a database for storing various kinds of the data signal Da. The data signal Da may be formed of a tone-based audio, a piece of music content, a binary string, text or symbols. The data signal I)a may be comprehended by human or may be a randomly generated signal. In alternative embodiments, the data generator 106 is configured to generate the data content I)a in response to the controller 112.

The data encoder 108 is configured to generate an encoded data De in response to the data Da from the data generator 106. The encoded data De may comprise digital samples. In some embodiments, the data encoder 108 is configured to generate a mapping between the original data Da and the encoded output De. The mapping may be implemented using a look-up table. In some embodiments, the data encoder 108 comprises a data compressing module (not shown) configured to perform data sampling or compression against the encoded output De in order to increase the transmission efficiency. In some embodiments, the data encoder 108 may comprise an error correction module (not shown) which supports error correction functions. In some embodiments, the data encoder 108 comprises an encryption module (not shown) supporting encryption mechanism on the encoded output De so as to provide better protection for the information data or control data Da.

In some embodiments, the data encoder 108 is configured to encode the data Da through a modulation scheme. The data encoder 108 may be configured to take different modulation schemes, including amplitude shift keying (ASK), frequency-shift keying (FSK), phase-shift keying (PSK), quadrature-amplitude modulation (QAM), etc. In some embodiments, the data generator 106 or the data encoder 108 may comprise a processor, such as a digital signal processor (DSP), configured to perform data generation or modulation. In some embodiments, the encoded data De may be represented in terms of digital samples which are regarded as a digital-domain counterpart of the analog waveform of the data Da.

The signal combiner 110 is configured to generate a combined signal Sb in response to the encoded audio signal Sc and the encoded data De. In some embodiments, the encoded data De is embedded or inserted into the audio signal Sc by the data combiner 110. In some embodiments, the signal combiner 110 may comprise a signal mixer (not shown) or a signal adder (not shown) for implementing the signal combination.

As discussed previously, the audio signal Sc or the encoded data signal De may take the form of digital samples. As a result, the signal combiner 110 is configured to combine the samples from the encoded data signal De and those from the audio signal Sc. In some embodiments, the signal combiner 110 is configured to fragment the audio signal Sc into multiple units, such as frames, packets or payloads. In some embodiments, the signal combiner 110 may further introduce transmission overheads prefixed at such data units for recognition in signal reception. In some embodiments, the signal combiner 110 may dispatch the audio signal Sc to different units with comparable sizes. In the present disclosure, the samples of the encoded data De are regarded as virtual audio samples in the audio signal Sc, and transmitted along with audio signal samples Sc. As a result, data recovering modules in the receiving side corresponding to the transmitter 100 would deem the fragmented units of the data-embedded audio signal Sc as ordinary audio signal units if not otherwise informed of the data signal De presence.

Existing transmission approaches for carrying both the audio signals and the data signals require a specific treatment for such data signals. For example, an additional channel may be specified to be separate from the audio channel. Transmission using such channels is performed along with compatibility testing or license permission. Consequently, the transmission scheme would be inevitably more complicated. The required wireless bandwidth would also be larger. In addition, compatibility testing and licensing issues may also incur unnecessary development cycles and costs. On the contrary, the present disclosure proposes a data embedding approach where the control or information data is transmitted through the frame, payload or channel used originally for the audio signal only. By deliberate processing through embedding the data signal samples into the audio signal samples and streaming the processed audio samples, the audio quality can be maintained with substantially none or little noticeable interference being perceived when the audio content is output.

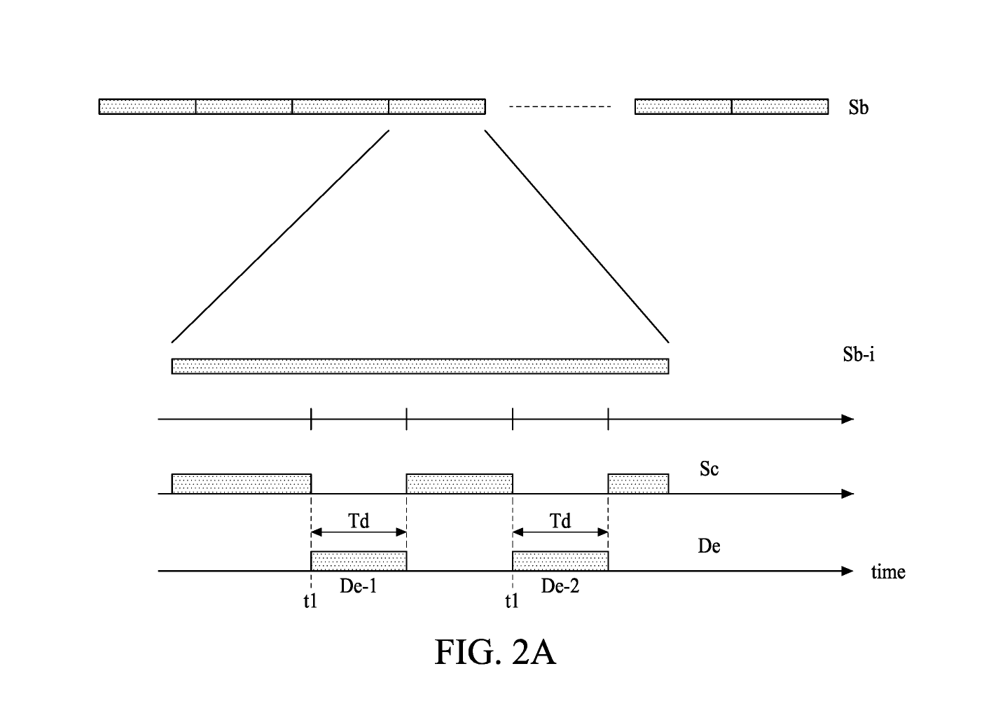

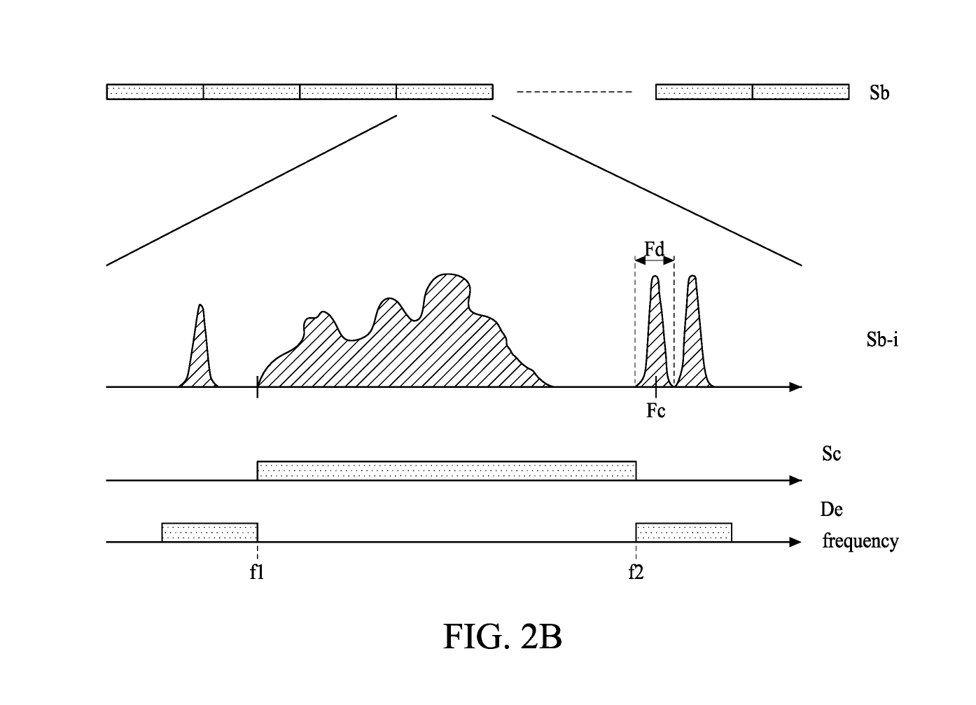

The audio signal Sc and the encoded data Dc may be combined with various modes that perform data combination in different domains, such as a time-domain combination or frequency-domain combination, as illustrated and described later with reference to FIGS. 2A and 2B. In addition, the signal combination (embedding) procedure may be further controlled by adjustable embedding parameters. In some embodiments, the embedding parameters are determined by the signal combiner 110 itself. In some embodiments, the embedding parameters are determined and provided by the controller 112. The embedding parameter may include, for example, at least one of a data embedding mode, a number of data pieces to be embedded, a starting time location for data embedding, an embedding time period, a center frequency and a bandwidth for data embedding.

The second audio signal encoder 118 is configured to encode the combined audio signal Sb into an encoded signal Se. In some embodiments, the second audio signal encoder 118 is configured to perform compression against the combined audio signal Sb in compliance with standardized formats, such as an MPEG-1 Audio Layer 3 (MP3) and Advanced Audio Coding (AAC). The second audio signal encoder 118 may be configured to determine coding parameters, such as bit rate and band number, for the respective encoding formats. In some embodiments, the coding parameters are received from another element, such as the controller 112, external to the second audio signal encoder 108. In some embodiments, the coding parameters are received from a processor external to the transmitter 100.

The controller 112 is configured to control the data generator 106. In addition, the controller 112 is configured to control the process of data embedding (data combination) of the data combiner 110. In some embodiments, the controller 112 is configured to store the embedding parameters associated with the data embedding mode. In some embodiments, some information or data, such as the control data Da, may be provided by a processor external to the transmitter 100 and sent through the controller 112.

The modulation module (MOD) 120 may be configured to convert the encoded signal Se into a radio frequency signal Sm. The modulation module 120 may be configured to perform several functions, such as modulation, up-conversion and filtering. The modulation module 120 may also be configured to up-convert the encoded audio signal Sc into a band-pass signal suitable for transmission in a predetermined wireless band or carrier. The predetermined band or carrier available for the up-converted signal Sm may comply with one of the wireless standards, such as 3GPP, WiFi, Bluetooth, etc. Parameters of the predetermined carrier include the center frequency and bandwidth of the encoded data signal Sm. In some embodiments, the modulation module 120 comprises one of a signal mixer, waveform generator, multiplexer, band-pass filter and registers for implementing the functions mentioned above.

The transmitter 100 may further comprise a transmit antenna 130 configured to emit the radio frequency signal Sm to a receiving side. The transmit antenna 130 may be configured to transmit the radio frequency signal Sm in a single band or several bands.

FIG. 2A is a block diagram of a time-domain embedding scheme for the transmitter 100 of FIG. 1, in accordance with some embodiments of the present disclosure. The embedded audio signal Sb may comprise a sequence of data segments Sb-i, such as data frames, data packets, or payloads. An exemplary zoom-in data segment Sb-i is also shown along a time scale for illustrating the component signals thereof. The data segment Sb-i may comprise several digital samples composed of samples from the encoded audio signal Sc and those from the encoded data Dc. When the time-domain embedding scheme is determined, e.g., by the controller 112, the encoded data De is generated, which spans a period of time Td. In some embodiments, several encoded data signals De are generated and embedded. In addition, the data signal De is embedded within at least one of the segments Sb-i. Taking music streaming as an example, the encoded audio signal Sc represents the music content to be streamed, the data signal De-1 may represent one type of background information associated with the music content, and the data signal De-2 may represent a control instruction for such music content.

More details of the embedding parameters may be needed in performing the time-domain embedding mode. For example, the embedding parameters may comprise a starting position t1 for the data signal De-1 and a starting position t2 for the data signal De-2. The embedding parameters may also include a data period Td for each encoded data signal De. In the present embodiment, the data period Td is equal for both of the data signals De-1 and De-2. In some embodiments, the data period Td may be different among different data signals in different applications.

The embedding process with a time-domain mode may cause loss of content of the audio signal Sc during the period Td when the music content is overwritten with the data signal Dc. When the combined audio signal Sb is output, the portion of the data signal De may not be in harmony with the original audio signal Sc. Thus, the signal De may be regarded as interference or noise-like sound if output as an ordinary audio signal. In the present disclosure, the period Td is properly determined so as not to induce noticeable noise or interference to human hearing. On one hand, the period Td should be large enough so as to carry sufficient data. On the other hand, the period Td is required to be relatively short beyond the perception limit of human hearing. In an embodiment, the period Td is not greater than about 200 milliseconds. In an embodiment, the period Td is from about 10 milliseconds to about 100 milliseconds. In an embodiment, the period Td is from about 100 milliseconds to about 200 milliseconds.

In the present embodiment, as shown in FIG. 2A, the encoded data De is separate from that of the audio signal Sc. In some embodiments, a portion of the data signal De may be overlapped with the audio signal Sc. In other words, the starting location ti or t2 may fall within the time period where the audio signal Sc is transmitted. The audio signal Sc may be regarded as a source of interference or noise for the concurrently transmitted encoded data De, and vice versa. In that situation, an embedding scheme is proposed by adjusting an appropriate ratio of signal amplitudes or a percentage of overlapped portions between the audio signal Sc and the data signal De. In an embodiment, the data signal De is partially overlapped with the audio signal Sc and partially located in vacant periods where no audio signal Sc is transmitted.

FIG. 2B is a block diagram of a frequency-domain embedding scheme for the transmitter 100 of FIG. 1, in accordance with some embodiments of the present disclosure. Another exemplary zoom-in data segment Sb-i is also shown along a frequency scale for illustrating the component signals thereof. The data segment Sb-i may comprise several digital samples composed of the samples of the encoded audio signal Sc and the samples of the encoded data De. Referring to FIG. 29, different from the signal representation in terms of time scale in FIG. 2A, the sample group from the data signal De may not be distinguishable from that of the audio signals Sc in terms of time since both sample groups share the combined signal samples Sb in common. However, the encoded audio signal Sc and the encoded data De are distinguishable in frequency. This is because the original audio content Sa usually occupies a finite bandwidth smaller than the bandwidth of the combined signal Sb and the frequency-domain embedding mode takes advantage of such circumstance. Therefore, it is desired to embed the encoded data De into the audio signal Sc at frequencies not occupied by the audio signals Sc. For example, the audio signal Sc is transmitted at frequencies between a lower f1 and an upper f2. Accordingly, the encoded data De is embedded at frequencies lower than the lower limit f1 or higher than the upper limit f2. In some embodiments, in a frequency-domain embedding mode, the encoded data De may occupy a frequency bandwidth Fd at a center frequency Fc. The center frequencies Fc and the respective bandwidths Fd for adjacent data signals De may be separated from each other with a guard band in order to prevent inter-band interference.

The embedding procedure with a frequency-domain scheme may not cause content loss of the audio signal Sc since the audio signal Sc and the encoded data signal De are separate in frequency. When the frequency Fd is beyond the perception range of human hearing, the data signal De may be transparent to human hearing and can be detected only by a data detection module when the audio signal Sc is received. In the present disclosure, the frequency of the band Fd of the encoded data signal De is determined so as to fall beyond the audible range of human hearing. It is found that human hearing range is within a range from about 20 hertz to about 20 kilohertz in a laboratory testing. In an embodiment, the frequency of the encoded data signal De is not greater than 20 Hertz. In an embodiment, the frequency of the encoded data signal De is greater than 20 kilohertz.

In practical environments, human beings can hardly hear equally clear sounds within such a wide range mentioned above, especially near the hearing boundary of 20 or 20 kilohertz. Therefore, it is practical to adopt a smaller audible range in order to facilitate the embedding of the data signal De. In an embodiment, the frequency of the encoded data signal De is not greater than 30 Hertz. In an embodiment, the frequency of the encoded data signal De is not greater than 40 Hertz In an embodiment, the frequency of the encoded data signal De is greater than 15 kilohertz. In an embodiment, the frequency of the encoded data signal De is greater than 12 kilohertz.

In some embodiments, the time-domain embedding scheme and the frequency-domain embedding scheme illustrated in FIG. 2A and FIG. 2B, respectively, can be utilized individually or in combination. For example, the encoded data may be embedded in a time-frequency grid with a bandwidth Fh and a period Th. In an embodiment, the encoded data may be embedded where the band Fh is separate from a frequency range [fh1, fh2], and the period Th is determined as less than 200 milliseconds for example. In an embodiment, the data signal may be embedded where the band Fh is partially overlapped with the audible frequency range [fh1, fh2] and the period Th is disposed to be partially overlapped with the audio signal Sc.

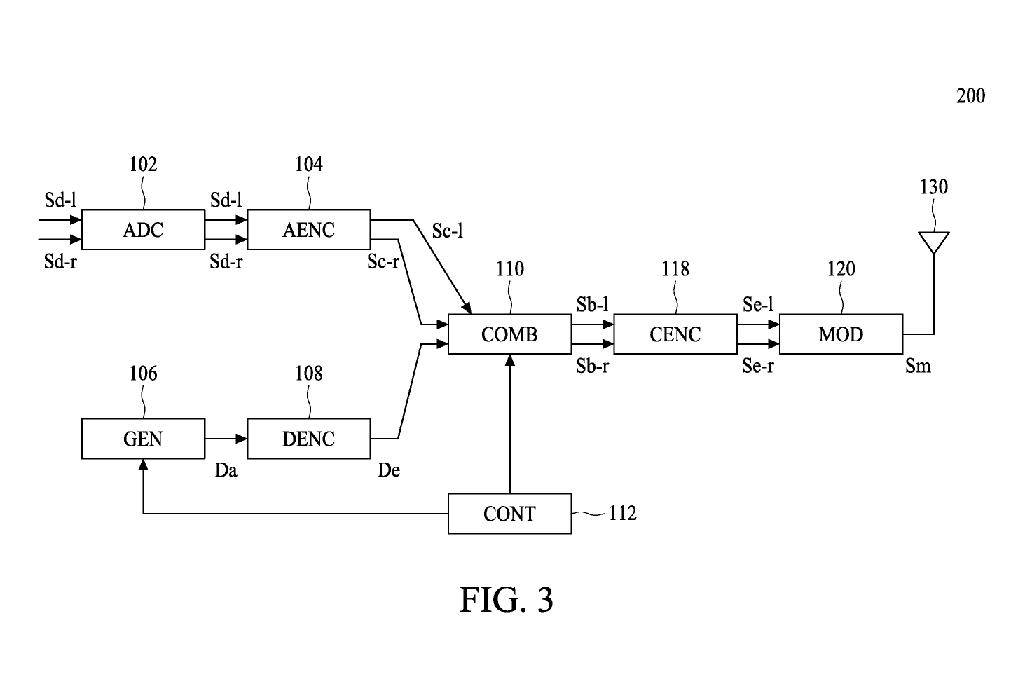

In some embodiments, the input audio signal Sa may support a stereo sound effect by providing at least two component signals. For example, the input audio signal may provide an audio signal pair, including a left-channel signal and a right-channel signal, for exhibiting the stereo sound effect. FIG. 3 shows a block diagram of a transmitter 200, for transmitting a stereo channel pair, in accordance with some embodiments of the present disclosure. The input audio signal Sa comprises a left-channel signal Sa-1 and a right-channel signal Sa-r. Furthermore, the ADC 102 is configured to generate a digital left-channel signal Sd-1 and a digital right-channel signal Sd-r. Similarly, the first audio signal encoder 104 is configured to generate a left-channel audio signal Sc-1 and a right-channel audio signal Sc-r in response to the signals Sd-1 and Sd-r, respectively.

The signal combiner 110 is configured to embed the encoded data De into the signal pair Sc comprising the signals Sc-1 and Sc-r, and provide a left-channel output Sb-1 and a right-channel output Sb-r. Subsequently, the second audio signal encoder 118 is configured to encode the combined audio signals Sb-1 and Sb-r into encoded audio signals Se-1 and Se-r, respectively. Additionally, the modulation module 120 is configured to generate a modulated and up-converted signal Sm in response to the encoded audio signals Se-1 and Se-r.

In some embodiments, the encoded data De is embedded into at least one of the two audio signals (i.e., Sc-1 and Sc-r). In an embodiment, the encoded data signal De is embedded into only one of the stereo channel pair; either the left-channel audio Sc-1 or the right-channel audio Sc-r. In an embodiment, several time-frequency grids are allocated in both the left-channel audio Sc-1 and the right-channel audio Sc-r. In an embodiment, duplicate encoded data signals De are embedded into the audio signal pair Sc for improving data protection.

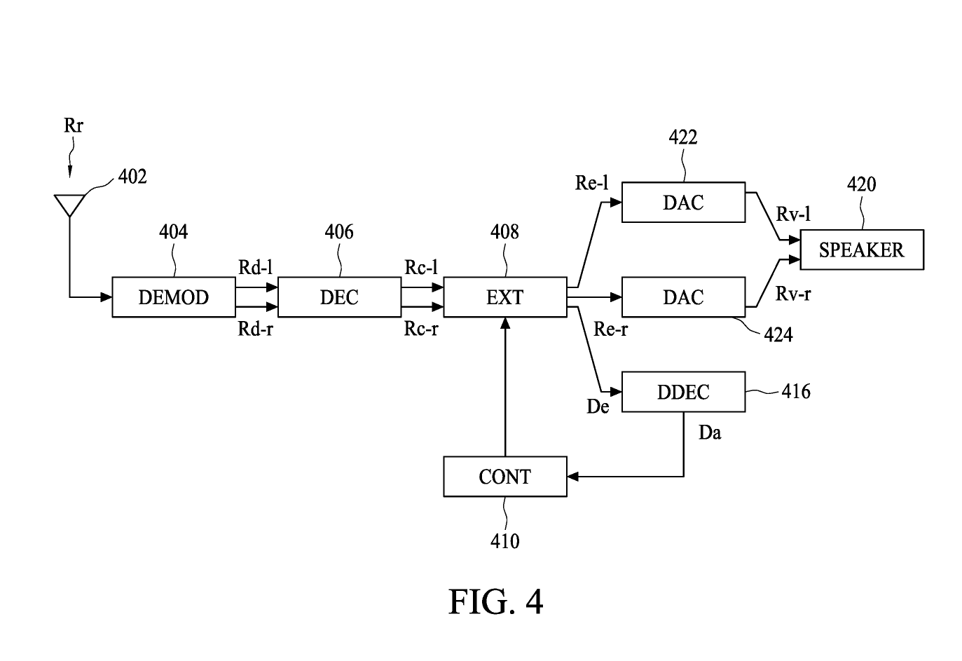

FIG. 4 is a block diagram of a receiver 400 in accordance with some embodiments of the present disclosure. The receiver 400 comprises a receiving antenna. 402, a demodulation (DEMOD) module 404, an audio decoder 406, a signal extractor 408, digital-to-analog converters (DACs) 422 and 424, a data decoder (DDEC) 416, a speaker 420 and a controller (CONT) 410.

The receiving antenna 402 is configured to receive a radio frequency signal Rr. Then, the demodulation module 404 is configured to down-convert the radio frequency signal Rr into a baseband signal Rd. In some embodiments, the demodulation module 404 is configured to generate a signal pair Rd comprising a left-channel audio signal Rd-1 and a right-channel audio signal Rd-r. In some embodiments, when only a monochannel audio signal Rd is received, the demodulation module 404 is configured to output an identical signal Rd for both the right-channel signal and the left-channel signal. In some embodiments, the demodulation module 404 comprises a mixer or matched filter, configured to perform signal demodulation or data sampling so as to derive digital samples of the audio signal Rc. In some embodiments, the demodulation module 404 comprises one of the signal mixer, waveform generator, multiplexer, low-pass filter and registers for implementing the functions mentioned above.

The audio signal decoder 406 is configured to decode the audio signal pair Rd into a decoded audio signal pair Re comprising a left-channel signal Re-1 and a right-channel signal Rc-r. In an embodiment, the decoder 406 performs signal decoding in compliance with one of the established coding protocols, such as AAC or MP3. The decoded audio signal pair Re is regarded as a digital counterpart of an original audio waveform free of encoding.

The signal extractor 408 is configured to detect whether a data embedding mode is utilized against the received audio signal pair Re. In some embodiments, a data field or a flag signal may be used as an indicator showing that the data embedding mode is used in the currently streamed audio. In an embodiment, the data field or flag signal may be transmitted external to the data signal De. In alternative embodiment, the data field or flag signal may be transmitted along with the data signal De. The data field or the flag signal may be detected in advance of the detection of the data signal De. In some embodiments, the signal extractor 408 is configured to routinely perform operations of data extraction based on default data embedding parameters. In some embodiments, the signal extractor 408 is configured to perform data extraction in response to the embedding parameters provided from the controller 410. In some embodiments, the signal extractor 408 comprises signal adder or shift registers configured to implement signal subtraction.

When the time-domain embedding mode is used, the signal extractor 408 is configured to perform data extraction along time. In an embodiment, the signal extractor 408 is configured to extract a data signal De at a time slot of at least one of the left-channel signal Re-1 and the right-channel signal Rc-r. Furthermore, the extracted data signal De is sent to the data decoder 416.

The decoded data signal De is sent to the controller 410 for further processing, or displayed on a screen. However, for the period where the time slot resides, which carries the data signal De before signal extraction, there is no audio content available for streaming after signal extraction. Such time slot may be regarded vacant or unused if no further processing is performed. In the present disclosure, the audio content of the other signal channel of the signal pair Re is leveraged to substitute in the unused period of the time slot. In other words, during the period of such time slot, the stereo output audio signal Re is arranged to provide a duplicate mono-channel audio signal, rather than a stereo audio content, in both the left-channel signal Re-1 and the right-channel signal Re-r. In some embodiments, one channel signal out of the stereo signal pair, during the period of the time slot, is substituted with the other channel signal not embedding the data signal.

In some embodiments, the signal extractor 408 comprises a switch configured to perform the operation of audio signal substitution or duplication in the time-division embedding mode. In some embodiments, the switch is configured to connect the inputs of both of the audio decoders 412 and 414 to one output of the signal extractor 408, such that the stereo signal pair is provided with a single output of the signal extractor 408 during the period of the time slot for the data signal.

In some embodiments, the time slot where the data signal is previously disposed may be arranged to stay silent. In other words, no specific signal or audio content is to he substituted into the unused period; the audio content from the other channel would also not be substituted to the unused period. Since the period of the time slot is determined to be relatively short in relation to human hearing, there would be no perceivable interruption or discontinuity to a user. The user experience of the stereo sound effect would not be adversely impacted.

Subsequently, the DACs 422 and 424 are configured to convert the processed audio samples of the left-channel signal Re-I and the right-channel signal Re-r into an analog form as signals Rv-1 and Rv-r. Then, the speaker 420 is configured to deliver the recovered and processed audio signals Rv-1 and Rv-r to the listener. In some embodiments, alternative devices, such as a headset, can be used to play the audio signals Rv-1 and Rv-r. In some embodiments, the DACs 422 or 424 is constructed by one of the switch, operational amplifier, resistor, or combination thereof.

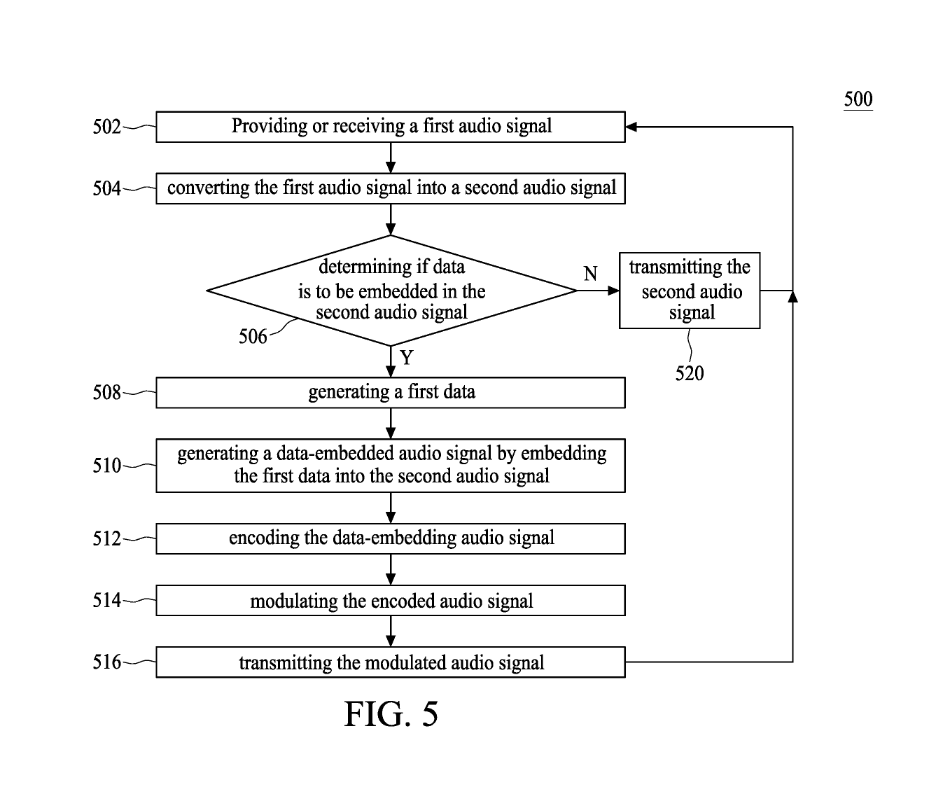

FIG. 5 is a flow diagram of a communication method 500 in accordance with some embodiments of the present disclosure. In operation 502, a first audio signal is provided or received.

In operation 504, the first audio signal is converted into a second audio signal. In some embodiments, the conversion process may comprise sampling of the first audio signal into a digitized counterpart of the first audio signal. In some embodiments, the conversion process comprises data compression.

In operation 506, the method 500 is configured to determine if data is to be embedded in the second audio signal. In some embodiments, embedding parameters associated with the data embedding mode are also generated or determined in operation 506. If confirmative, a first data is generated in operation 508. Otherwise, the second audio signal is transmitted directly in operation 520, and the method 500 returns to operation 502 for a next audio signal.

in operation 510, a data-embedded audio signal is generated by embedding the first data into the second audio signal in response to the data embedding mode as being used. In some embodiments, the data-embedded audio signal also comprises the embedding parameters associated with the embedded data.

Then, in operation 512, the data-embedded audio signal is encoded into an encoded audio signal. In an embodiment, the encoding operation is performed in compliance with one of the established encoding protocols, such as AAC or MP3. Subsequently, a modulated audio signal is generated by modulating the encoded audio signal in operation 514.

In operation 516, the modulated audio signal is transmitted and the method 500 returns to operation 502 until the end of the audio signal. In some embodiments, the transmission operation comprises up-converting to a radio frequency band and emitting the radio frequency audio signal via a transmit antenna.

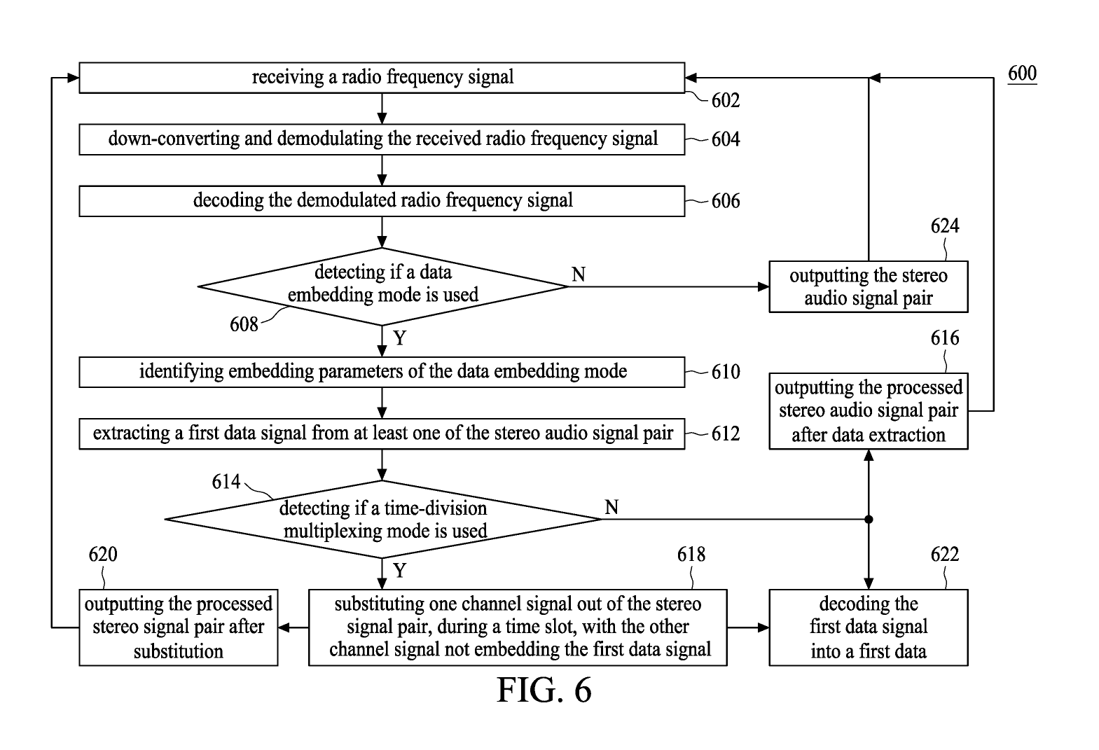

FIG. 6 shows a flow diagram of a communication method 600 in accordance with some embodiments of the present disclosure. In operation 602, a radio frequency signal is received.

In operation 604, the received radio frequency signal is down-converted and demodulated. In some embodiments, the demodulated signal is formed of digital audio samples. In sonic embodiments, the demodulated audio signal comprises a stereo audio signal pair. In operation 606, the demodulated audio signal is decoded. In some embodiments, the decoded audio signal is a discrete-time counterpart of its analog audio waveform. In some embodiments, the decoded audio signal comprises a stereo audio signal pair.

Then, it is detected in operation 608 if a data embedding mode is used. If confirmative, embedding parameters of the data embedding mode are identified in operation 610. Otherwise, if it is detected that no data embedding mode is used for the currently demodulated signal, the stereo audio signal pair is output in operation 624. Then the method 600 returns to operation 602 for receiving another radio frequency signal. In some embodiments, a default set of embedding parameter values may be stored or supplied in advance. In that case the operation of identifying the embedding parameters may not be necessary every time for performing data extraction.

In operation 612, a first data signal is extracted from at least one of the stereo audio signal pair. The extraction approach is different depending on the data embedding mode. In some embodiments, the data extraction process is performed based on the embedding parameters associated therewith.

In operation 614, it is detected if a time-division embedding mode is used. If affirmative, in operation 618, one channel signal out of the stereo signal pair is substituted, during a period of a time slot for the first data, with the other channel signal riot embedding the first data. Then, the processed stereo signal pair after substitution is output in operation 620 and the method 600 returns to operation 602 for receiving a next radio frequency signal. In addition, the first data signal is decoded into a first data in operation 622.

If it is detected that no time-division embedding mode is used in operation 614, it is presumed that a frequency-division embedding mode or other alternative is used as the data embedding mode. Then the processed audio signal after data extraction is output in operation 616, and the method 600 returns to operation 602. In addition, the first data signal is decoded into a first data in operation 622.

In sonic embodiments, when a time-division multiplexing mode is used, the time period for the first data signal is left silent. Also, the method 600 proceeds to operation 616 where the processed stereo audio signal pair after data extraction is output.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a radio frequency signal;
generating a first radio signal by demodulating and decoding the received radio frequency signal;
detecting if a data embedding mode is used;
extracting a first data signal from the first radio signal in response to the data embedding mode as being detected; and
outputting the processed first radio signal after extraction.

2. The method according to claim 1, wherein extracting a first data signal from the first radio signal comprises:
extracting the first data signal from the first audio signal; and
outputting the processed first audio signal after extraction in response to a frequency-embedding mode.

3. The method according to claim 1, wherein the first audio signal comprises a stereo signal pair including two channels, and extracting a first data signal from the first audio signal comprises:
detecting if a time-embedding mode is used; and
extracting the first data signal from one of the stereo signal pair during a first period in response to the time-embedding mode as being used.

4. The method according to claim 3, further comprising:
substituting one channel signal out of the stereo signal pair, during the first period, with the other channel signal not embedding the first data signal, and
outputting the stereo signal pair.

5. The method according to claim 4, wherein substituting one channel signal out of the stereo signal pair, during the first period, with the other channel signal not embedding the first data signal and outputting the stereo signal pair comprises outputting one signal to both channels of the stereo signal pair with a switch during the first period.

6. The method according to claim 1, further comprising identifying, before extracting the first data signal from the first audio signal, embedding parameters associated with the data embedding mode.

7. The method according to claim 6, wherein the embedding parameters comprise a time-division embedding mode and a frequency-division embedding mode.

8. The method according to claim 6, wherein the embedding parameters comprise a first period, during which the first data signal is embedded into the first audio signal, and the first period is not greater than 200 milliseconds.

9. The method according to claim 6, wherein the embedding parameters further comprise a frequency limit for the frequency-embedding mode as below 30 kilohertz or above 15 kilohertz.

10. The method according to claim 1, wherein the first audio signal is divided into a plurality of segments, and the first data signal is embedded within at least one of the plurality of segments.

11. The method according to claim 1, before receiving the radio frequency signal, further comprising:
providing a second audio signal;
encoding the second audio signal into a third audio signal;
determining if the data embedding mode is used;
generating a data-embedding audio signal comprising the second audio signal and the first data signal in response to the data embedding mode as being used; and
transmitting the data-embedding audio signal.

12. The method according to claim 11, before generating a data-embedding audio signal comprising the second audio signal and the first data signal, further comprising:
generating a first data; and
encoding the first data into the first data signal.

13. A transmitter, comprising:
a first encoder, configured to generate an audio signal;
a second encoder, configured to generate a data signal;
a controller, configured to determine a data embedding mode and parameters associated therewith for the audio signal and the data signal; and
a signal combiner, configured to generate a data-embedding audio signal by embedding the data signal into the audio signal in response to the controller.

14. The transmitter according to claim 13, wherein the data embedding mode comprises a time-division embedding scheme and a frequency-domain embedding scheme.

15. The transmitter according to claim 13, wherein the signal combiner is configured to divide the audio signal into a plurality of segments and embed the data signal into at least one of the plurality of segments.

16. The transmitter according to claim 13, wherein the data combiner is configured to embed the data signal at a frequency higher than 15 kilohertz in the audio signal.

17. A receiver, comprising:
a demodulation module, configured to generate a first audio signal from a radio frequency signal;
a controller, configured to detect a data embedding mode and parameters associated thereto for the first audio signal; and
a signal extractor, configured to extract a data signal from the first audio signal based on the data embedding mode and the parameters.

18. The receiver according to claim 17, wherein the receiver further comprises a speaker, and the controller is further configured to:
extract a first data signal from the first audio signal in response to the data embedding mode as being detected; and
output the processed first audio signal after extraction to the speaker.

19. The receiver according to claim 17, wherein the first audio signal comprises a stereo signal pair, and the signal extractor is further configured to:
substitute one out of the stereo signal pair, during a first period for the data signal, with the other one not embedding the first data signal in response to the data embedding mode as a time-division embedding mode; and
output the processed stereo signal pair to the speaker.

20. The receiver according to claim 19, wherein the signal extractor comprises a switch configured couple one output thereof to inputs of the speaker, such that the stereo signal pair is output with a single output of the signal extractor during the period for the first data signal.
